(19) United States
(12) Patent Application Publication
(10) Pub. No.: US 2024/0008454 A1
(43) Pub. Date: Jan. 11, 2024

(54) Retractable Leash Device

(71) Applicant: Lindsay Morcos, San Clemente, CA (US)

(72) Inventor: Lindsay Morcos, San Clemente, CA (US)

(21) Appl. No.: 18/310,668

(22) Filed: May 2, 2023

Related U.S. Application Data
(60) Provisional application No. 63/359,450, filed on Jul. 8, 2022.

(51) Int. Cl. A01K 27/00; A01K 1/04

(52) U.S. Cl. CPC A01K 27/004; A01K 1/04

(57) ABSTRACT

The present invention relates to a retractable leash device used for pet training or pet leisure. The device is primarily comprised of a base having at least one handle and at least one spool with at least one leash. The handle of the base can be anchored to the ground during use via a ground stake stored within the handle. The spool can be unwound to allow the leash to achieve any length. The spool can also be spun via a plurality of means such as, but not limited to, a crank handle, a spring, and a motor to forcibly re-wind the leash around the spool.

### CROSS-REFERENCE TO RELATED APPLICATION

The present application claims priority to, and the benefit of, U.S. Provisional Application No. 63/359,450, which was filed on Jul. 8, 2022, and is incorporated herein by reference in its entirety.

### FIELD OF THE INVENTION

The present invention relates generally to the field of pet leashes. More specifically, the present invention relates to a retractable leash device primarily comprised of a base having at least one handle and at least one spool with at least one leash. The handle of the base can be anchored to the ground during use via a ground stake stored within the handle. The spool can be unwound to allow the leash to achieve any length and can be spun via a plurality of means such as, but not limited to, a crank handle, a spring, and a motor. In this manner, the leash is re-wound around the spool. Accordingly, the present disclosure makes specific reference thereto. Nonetheless, it is to be appreciated that aspects of the present invention are also equally applicable to other like applications, devices, and methods of manufacture.

### BACKGROUND

Training pets can be a difficult task even for experienced pet trainers. While training outdoors, most pet trainers keep the pet on a leash. However, pets may get loose by breaking or pulling on the leash and may suffer serious injuries if they run into a busy roadway. Further, if a pet is loose and off of a leash, it may jump, bite, and/or harm other nearby individuals. In addition, an off-leash pet may approach another animal that is not friendly, thereby causing a fight between animals and causing potential injury if a human tries to break up the fight.

Further, existing pet leashes have fixed maximum lengths that are often too short for a pet owner's and pet trainers preferences. In addition, a leash may slip out of a pet owner's hand, allowing the pet to escape. Also, existing pet leashes do not allow a pet owner to easily retract the leash, especially while the pet is resisting the retraction. Existing leashes do not allow pet owners and pet trainers to train and play with their pets hands free and without the use of inhumane tactics or the fear of the pet running away.

Therefore, there exists a long-felt need in the art for an improved leash. There also exists a long-felt need in the art for a retractable leash device that provides a longer maximum length than existing leashes known in the art. Further, there exists a long-felt need in the art for a retractable leash device that does not slip out of a pet owner's hand during use, thereby preventing a pet attached to the leash to escape. In addition, there exists a long-felt need in the art for a retractable leash device that provides a means to forcibly retract the leash.

The subject matter disclosed and claimed herein, in one embodiment thereof, comprises a retractable leash device. The device is primarily comprised of a base having at least one handle and at least one spool with at least one leash. The handle of the base can be anchored to the ground during use via a ground stake stored within the handle. The spool can be unwound to allow the leash to achieve any length. The spool can be spun via a plurality of means such as, but not limited to, a crank handle, a spring, and a motor such that the leash is re-wound around the spool. When not in use, the handle can be folded to allow the device to be easily carried.

In this manner, the retractable leash device of the present invention accomplishes all of the foregoing objectives and provides a device that provides a longer maximum length than existing leashes known in the art. Further, the device does not slip out of a pet owner's or pet trainers hand during use, thereby preventing a pet from escaping or preventing harm to handler if animal pulls. In addition, the device provides a novel means to forcibly retract the leash.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a retractable leash device. The device is primarily comprised of a base having at least one handle and at least one spool with at least one leash. The base preferably has a top wall, a bottom wall, and a plurality of side walls. The base has at least one handle preferably connected to the base by at least one hinge that allows the handle to fold upward such that the device can be easily carried via the handle when not in use. The handle also folds outward such that it is perpendicular to the side wall of the base. Then, at least one ground stake can be used to secure each handle to a ground surface. When not in use, the ground stake can be stored in a recessed area within the handle.

The top wall of the base is comprised of at least one rotating base that rotates 360 degrees around at least one vertical axle within the base. At least one spool is attached to the base and houses at least one leash. The leash is comprised of at least one fastener that allows the leash to be clipped to a pet collar or harness.

The base, rotating base, cross member, and/or any structure of the device may be comprised of at least one button that engages and/or disengages at least one locking mechanism. The locking mechanism allows a user to stop the leash at a fixed length. The leash can be retracted and re-wound around the spool as desired via a plurality of manners. In one embodiment, the spool is comprised of at least one crank handle that allows a user to rotate the handle to spin the spool around at least one axle to retract and re-wind the leash around the spool.

In another embodiment, the spool can be rotated to retract the leash and re-wind the leash around the spool using at least one motor that can be controlled by the button. The motor is powered by at least one battery. The battery may be recharged by a USB port of any type known in the art. In another embodiment, the motor is comprised of at least one transmitter that places the motor in wireless electrical communication with at least one transmitter of at least one remote. At least one button of the remote allows a user to activate the motor to re-wind the spool and retract the leash.

Accordingly, the retractable leash device of the present invention is particularly advantageous as it provides a device that provides a longer maximum length than existing leashes known in the art. The device also does not slip out of a pet owner's hand during use, thereby preventing a pet from escaping. In addition, the device provides a novel means to forcibly retract the leash. In this manner, the retractable leash device overcomes the limitations of existing pet leashes known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a retractable leash device of the present invention while secured to a ground surface in accordance with the disclosed architecture;

FIG. 2 illustrates a perspective view of the spool of one potential embodiment of a retractable leash device of the present invention while secured to a ground surface in accordance with the disclosed architecture; and

FIG. 3 illustrates a perspective view of one potential embodiment of a retractable leash device of the present invention while folded in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved leash. There also exists a long-felt need in the art for a retractable leash device that provides a longer maximum length than existing leashes known in the art. Further, there exists a long-felt need in the art for a retractable leash device that does not slip out of a pet owner's hand during use, thereby preventing a pet attached to the leash to escape. In addition, there exists a long-felt need in the art for a retractable leash device that provides a means to forcibly retract the leash.

The present invention, in one exemplary embodiment, is comprised of a retractable leash device primarily comprised of a base having at least one handle and at least one spool with at least one leash. The base preferably has a top wall, a bottom wall, and a plurality of side walls. The base has at least one handle preferably connected to the base by at least one hinge. The hinge allows the handle to fold upward such that the device can be easily carried via the handle when not in use. The handle also folds outward such that it is perpendicular to the side wall of the base, such that at least one ground stake can be used to secure each handle to a ground surface. When not in use, the ground stake can be stored in a recessed area within the handle.

The top wall of the base is comprised of at least one rotating base. The base rotates 360 degrees around at least one vertical axle within the base. At least one spool is attached to the base and houses at least one leash. The leash is comprised of at least one fastener or loop that allows the leash to be clipped to a pet collar or harness.

The base, rotating base, cross member, and/or any structure of the device may be comprised of at least one button that engages and/or disengages at least one locking mechanism. The locking mechanism allows a user to stop the leash at a fixed length. The leash can be retracted and re-wound around the spool as desired via a plurality of manners. The spool may be comprised of at least one crank handle that allows a user to rotate the handle to spin the spool around at least one axle to retract and re-wind the leash around the spool.

Alternatively, or additionally, the spool can be rotated to retract the leash and re-wind the leash around the spool using at least one motor that can be controlled by the button. The motor is powered by at least one battery. The battery may be recharged by a USB port of any type known in the art. In another embodiment, the motor is comprised of at least one transmitter that places the motor in wireless electrical communication with at least one transmitter of at least one remote. At least one button of the remote allows a user to activate the motor to re-wind the spool and retract the leash.

Accordingly, the retractable leash device of the present invention is particularly advantageous as it provides a device that provides a longer maximum length than existing leashes known in the art. The device also does not slip out of a pet owner's hand during use, thereby preventing a pet from escaping. In addition, the device provides a novel means to forcibly retract the leash. In this manner, the retractable leash device overcomes the limitations of existing pet leashes known in the art.

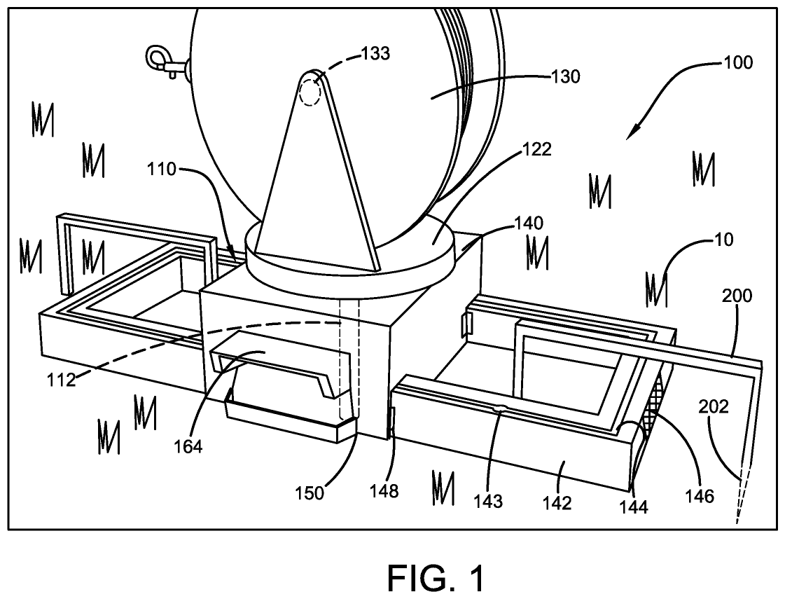

Referring initially to the drawings, FIG. 1 illustrates a perspective view of one potential embodiment of a retractable leash device 100 of the present invention while secured to a ground surface 10 in accordance with the disclosed architecture. The device 100 is primarily comprised of a base 110 having at least one handle 142 and at least one spool 130 with at least one leash 210. Unless otherwise specified, all components of the device 100 are preferably made from a durable metal such as, but not limited to, stainless steel or aluminum and/or a rigid plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In the preferred embodiment, the base 110 is generally square in shape. However, the base 110 may be any shape in different embodiments such as, but not limited to, circular, rectangular, etc. The base 110 preferably has a top wall 120, a bottom wall 150, and a plurality of side walls 140.

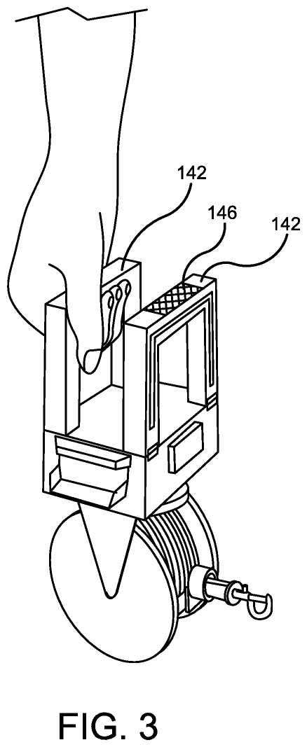

The base 110 has at least one handle 142 preferably connected to the base 110 by at least one hinge 148 on at least one side wall 140 and/or bottom wall 150. The hinge 148 may be any hinge type known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The hinge 148 allows the handle 142 to fold upward (i.e., parallel to the side walls 140) such that the device 100 can be easily carried via the handle 142 when not in use, as seen in FIG. 3. In one embodiment, the handle 142 is comprised of at least one grip area 146 that is recessed, flat, or raised. The grip area 146 is preferably made from a non-slip rubber material to improve grip such as, but not limited to, natural rubbers, neoprene rubber elastomer, silicone rubber elastomer, ethylene propylene diene monomer rubber, butyl rubber, nitrile rubber, buna-n rubber, styrene-butadiene rubber elastomers, Viton rubber elastomer, diaphragm rubber, thermoplastic rubber, etc.

In the preferred embodiment of the device 100 with two handles 142 (one handle 142 on each side of the base 110), the handles 142 fold outward such that they are perpendicular to the side walls 140. Then, at least one ground stake 200 can be used to secure each handle 142 to a ground surface 10. The ground stake 200 is preferably generally U-shaped such that it can be secured into a ground 10 surface on each side of each handle 142. Each end of the ground stake 200 is comprised of at least one pointed end 202 to facilitate easy penetration of the ground surface 10. When not in use, the ground stake 200 can be stored in a recessed area 144 within the handle 142. In one embodiment, the recessed area 144 is magnetic to better retain the stake 200 in an embodiment wherein the stake 200 is metal. However, it should be appreciated that the stake 200 may be any shape known in the art. In one embodiment, the stake 200 may be driven through at least one opening 143 in the handle 142 into the ground surface 10. In said embodiment, the stake 200 is preferably T-shaped.

The top wall 120 of the base 110 is comprised of at least one rotating base 122 that rotates 360 degrees around at least one vertical axle 112 within the base 110. At least one spool 130 is attached to the base 122. The spool 130 houses at least one leash 210. The leash 210 may be of any length, material, and construction of pet/animal leash known in the art. In one embodiment, the leash 210 is fixedly attached to the spool 130. In another embodiment, the leash 210 removably attaches to the spool via at least one spool fastener 138. The fastener 138 may be any fastener type such as, but not limited to, a clip, a hook and loop, a magnet, a tie, an opening, a groove, etc. In this manner, the leash 210 can be replaced as needed.

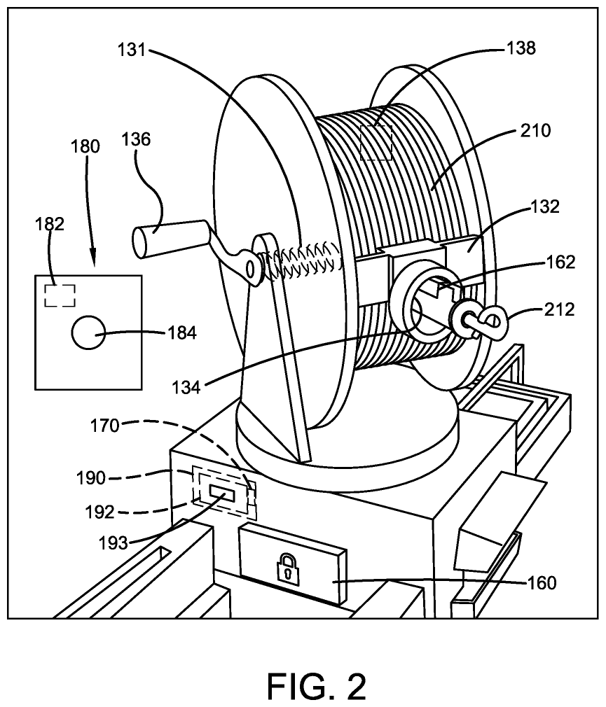

In one embodiment, the spool 130 is comprised of at least one cross member 132 with at least one opening 134, as seen in FIG. 2. The opening 134 allows the leash 210 to unwind from the spool 130 in a controlled manner. However, the opening 134 is preferably sized such that the leash 210 and at least one fastener 212 attached to the leash 210 cannot travel back into the spool 130 to allow the entire leash 210 to unwind from the spool 130. The fastener 212 may be any fastener type known in the art such as, but not limited to, a clip, a clasp, a tie, a snap button, a ring, etc., such that the leash 210 can be clipped to a pet collar or harness.

The base 110, rotating base 122, cross member 132, and/or any structure of the device 100 may be comprised of at least one button 160. Pressing the button 160 engages and/or disengages at least one locking mechanism 162. In one embodiment, the button 160 may alternatively be at least one foot pedal 164. The locking mechanism 162 allows a user to stop the leash 210 at a fixed length. In one embodiment, the locking mechanism 162 is a door that presses down on the opening 134 to prevent the leash 210 from increasing in length. In another embodiment, the locking mechanism 162 prevents the rotation of the spool 130. In one embodiment, the locking mechanism 162 may also inhibit the rotation of the rotating base 122 when engaged.

The leash 210 can be retracted and re-wound around the spool 130 as desired via a plurality of manners. In one embodiment, the spool 130 is comprised of at least one crank handle 136 that allows a user to rotate the handle 136 to spin the spool 130 around at least one axle 133. This retracts and re-winds the leash 210 around the spool 130. In one embodiment, the crank 136 may be assisted by at least one spring 131 of any spring type known in the art. In one embodiment, the spring 131 may automatically retract the leash 210 around the spool 130 when the button 160 is pressed.

In another embodiment, the spool 130 can be rotated to retract the leash 210 and re-wind the leash 210 around the spool using at least one motor 190 that can be controlled by the button 160. The motor 190 is powered by at least one battery 192. The battery 192 may be a disposable battery 192 or a rechargeable battery 192 in the form of an alkaline, nickel-cadmium, nickel-metal hydride battery 192, etc., such as any 3V-12 volts DC battery 192 or other conventional battery 192 such as A, AA, AAA, etc., that supplies power to the device 100. Throughout this specification the terms “battery” and “batteries” may be used interchangeably to refer to one or more wet or dry cells or batteries 192 of cells in which chemical energy is converted into electricity and used as a source of DC power. References to recharging or replacing batteries 192 may refer to recharging or replacing individual cells, individual batteries 192 of cells, or a package of multiple battery cells as is appropriate for any given battery 192 technology that may be used. Additionally, the battery 192 may be recharged by a USB port 193 of any type known in the art.

In another embodiment, the motor 190 is comprised of at least one receiver 170 that places the motor 190 in wireless electrical communication with at least one transmitter 182 of at least one remote 180. At least one button 184 of the remote 180 allows a user to activate the motor 190 to re-wind the spool 130 and retract the leash 210.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “retractable leash device” and “device” are interchangeable and refer to the retractable leash device 100 of the present invention.

Notwithstanding the foregoing, the retractable leash device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the retractable leash device 100 as shown in the FIGS. are for illustrative purposes only, and that many other sizes and shapes of the retractable leash device 100 are well within the scope of the present disclosure. Although the dimensions of the retractable leash device 100 are important design parameters for user convenience, the retractable leash device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A retractable leash device comprising:
a base;
a spool comprised of a crank handle;
a rotating base attached to a top wall of the base;
a leash comprised of a fastener;
a button;
a locking mechanism;
a handle; and
a ground stake.

2. The retractable leash device of claim 1, wherein the leash fixedly attaches to the spool.

3. The retractable leash device of claim 1, wherein the crank handle rotates the spool.

4. A retractable leash device comprising:
a base;
a spool comprised of a crank handle;
a rotating base attached to a top wall of the base;
a leash comprised of a leash fastener, the leash positioned around the spool;
a button;
a locking mechanism;
a handle attached to the base via a hinge, the handle comprised of a recessed area; and
a ground stake.

5. The retractable leash device of claim 4, wherein the handle is comprised of a grip area comprised of a recessed, a flat, or a raised non-slip rubber material.

6. The retractable leash device of claim 4, wherein the ground stake fits within the recessed area.

7. The retractable leash device of claim 6, wherein the recessed area is comprised of a magnetic recessed area.

8. The retractable leash device of claim 4, wherein the ground stake is comprised of a generally U-shaped ground stake.

9. The retractable leash device of claim 4, wherein the button activates the locking mechanism.

10. The retractable leash device of claim 9, wherein the locking mechanism inhibits the movement of the leash from around the spool.

11. The retractable leash device of claim 10, wherein the locking mechanism is positioned in an opening of a cross member of the spool.

12. A retractable leash device comprising:
a base;
a spool comprised of a crank handle;
a rotating base attached to a top wall of the base;
a leash comprised of a leash fastener, the leash positioned around and attached to the spool;
a button;
a locking mechanism;
a handle attached to the base via a hinge, the handle comprised of a recessed area;
a ground stake;
a motor comprised of a battery and a receiver; and
a remote comprised of a transmitter and a button.

13. The retractable leash device of claim 12, wherein the rotating base rotates 360 degrees around a vertical axle positioned within the base.

14. The retractable leash device of claim 12, wherein the leash removably attaches to the spool via a spool fastener.

15. The retractable leash device of claim 12, wherein the leash fastener is comprised of a clip, a clasp, a tie, a snap button, or a ring.

16. The retractable leash device of claim 12, wherein the motor rotates the spool.

17. The retractable leash device of claim 12, wherein the receiver of the motor is in wireless electrical communication with the transmitter of the remote.

18. The retractable leash device of claim 12, wherein the locking mechanism inhibits rotation of the rotating base.

19. The retractable leash device of claim 12, wherein the locking mechanism inhibits rotation of the spool.

20. The retractable leash device of claim 12, wherein the spool is comprised of an axle.
